(19) United States
(12) Patent Application Publication
(10) Pub. No.: US 2009/0070386 A1
(43) Pub. Date: Mar. 12, 2009

(54) CONTENT STORAGE MANAGEMENT APPARATUS AND METHOD FOR MANAGING STORED CONTENT

(75) Inventor: Naoki Yamanashi, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/126,774

(22) Filed: May 23, 2008

(30) Foreign Application Priority Data
Sep. 7, 2007 (JP) 2007233076

(51) Int. Cl. G06F 17/30

(52) U.S. Cl. 707/200; 707/E17.001

(57) ABSTRACT

A content storage management apparatus includes: a content input section to which content data including content and attribute information of the content are input; a content information storage section that stores the input content data and meta-information in an external storage device connected to the apparatus via a network, the meta-information being obtained for the content by analyzing the attribute information; a content classification information storage section that extracts classification information from the meta-information for the content and stores the classification information in a content information file on the external storage device; a content extraction section that extracts the content matching a specific type of the classification information from the content information file to be displayed as a list; and a listing information output section that outputs listing information for displaying the content matching the specific type of the classification information based on the extracted content.

### CROSS-REFERENCE TO RELATED APPLICATIONS

This application is based upon and claims the benefit of priority from Japanese Patent Application No. 2007-233076, filed on Sep. 7, 2007, the entire content of which are incorporated herein by reference.

### BACKGROUND

1. Field

One embodiment of the invention relates to a content storage management apparatus and a method for managing stored content for displaying a list of stored contents.

2. Description of the Related Art

In recent years, a TV receiver, a hard disk recorder, and the like capable of storing contents of received broadcast programs, etc., in storage such as an internal hard disk drive, have become widespread. The user of a viewer can store content in the TV receiver or the hard disk recorder for viewing the content later.

Recently, for storing image data or video data in storage, there is proposed a technique to store the data by folder in response to content for considering easiness of data search and improving access speed. An examples of such technique are disclosed in JP-A-2007-156680 and in JP-A-2006-178569.

There is proposed a technique to realize unified management or search easiness in management of content information, by using a database management system (DBMS), using a high-speed index file, and using virtual tree display. An example of such technique is disclosed in JP-A-9-214935.

Further, recently, a TV receiver that is connectable to external storage through a network has also been available. Such a TV receiver that is connectable through a network allows the user to store, namely, record contents of received broadcast programs, etc., in the external storage. To view any recorded program, the user operates to access the program stored in the external storage through the network to receive the program and viewed by the TV receiver.

However, when the stored contents are searched for any desired content in a case where the number of contents stored in the external storage increases, information of all contents must be searched and the time for displaying a recording list is prolonged. For example, if the user desires to display the stored contents being categorized as “drama” (having “drama” attribute) from among all the stored contents in a form of a list and select the content to be viewed out of the list, the “drama” contents must be extracted by searching the descriptions of meta-information of all contents for contents having the “drama” attribute according to a command of the user. Therefore, when the number of contents increases, a considerable time is required for processing of only displaying a recording list for the user to select content to be viewed.

### SUMMARY

According to a first aspect of the present invention, there is provided a content storage management apparatus including: a content input section to which content data including content and attribute information of the content are input; a content information storage section that stores the input content data and meta-information in an external storage device connected to the apparatus via a network, the meta-information being obtained for the content by analyzing the attribute information; a content classification information storage section that extracts classification information from the meta-information for the content and stores the classification information in a content information file on the external storage device; a content extraction section that extracts the content matching a specific type of the classification information from the content information file to be displayed as a list; and a listing information output section that outputs listing information for displaying the content matching the specific type of the classification information based on the extracted content.

According to a second aspect of the present invention, there is provided a method for managing stored content, the method including: inputting content data including content and attribute information of the content; obtaining meta-information for the content by analyzing the attribute information; storing the input content data and the meta-information in an external storage device connected to the apparatus via a network; extracting classification information from the meta-information for the content; storing the classification information in a content information file on the external storage device; extracting the content matching a specific type of the classification information from the content information file to be displayed as a list; and outputting listing information for displaying the content matching the specific type of the classification information based on the extracted content.

### BRIEF DESCRIPTION OF THE SEVERAL VIEWS OF THE DRAWINGS

A general configuration that implements the various feature of the invention will now be described with reference to the drawings. The drawings and the associated descriptions are provided to illustrate embodiments of the invention and not to limit the scope of the invention.

FIG. 1 is a drawing to show a configuration of a content storage management system according to an embodiment of the present invention.

FIG. 2 is a drawing to show an example of a content management screen according to the embodiment.

FIG. 3 is a drawing to describe a display example of a recording list according to the embodiment.

FIG. 4 is a drawing to show an example of a content information file according to the embodiment.

FIG. 5 is a drawing to describe a process in which a content information file is created from received program data according to the embodiment.

FIG. 6 is a drawing to describe processing of extracting specified content data and metafile from the content information file according to the embodiment.

FIG. 7 is a drawing to describe data addition to and data deletion from the content information file according to the embodiment.

FIG. 8 is a flowchart to show a flow example of recording list display processing according to the embodiment.

### DETAILED DESCRIPTION

Referring now to the accompanying drawings, there is shown an embodiment of the present invention.

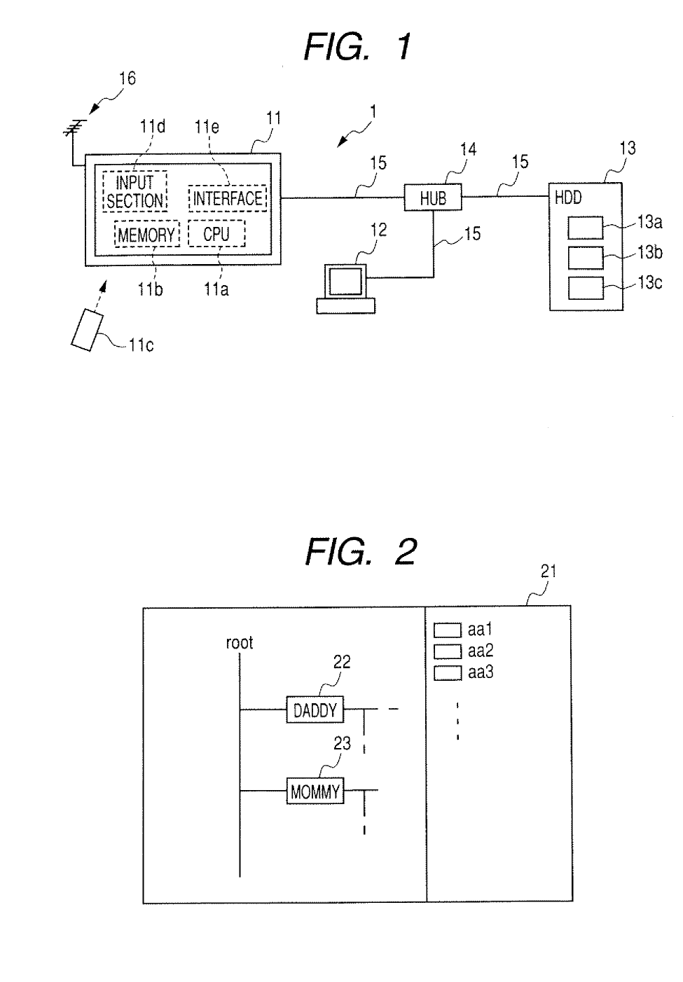

A configuration of a system according to the embodiment of the invention will be described by referring to FIG. 1. FIG. 1 is a drawing to show the configuration of a content storage management system according to the embodiment.

A content storage management system 1 shown in FIG. 1 is an example of a TV program storage management system of storing program content received by a TV receiver in external storage. The content storage management system 1 is made up of a TV receiver 11, a personal computer (PC) 12, and a hard disk drive (HDD) 13 as external storage. The TV receiver 11, the PC 12, and the HDD 13 are connected to a network 15 using a hub 14.

The TV receiver 11 can record, namely, store broadcast program content (which will be hereinafter referred simply as program) received from an antenna 16 in the HDD 13 in accordance with a command of the viewing user and the user can access the HDD 13 from the TV receiver 11, read data of the recorded program, and display the program on a screen of a display to view the program. Thus, the TV receiver 11 has a central processing unit (CPU) 11a and memory 11b of ROM, RAM, etc., and can execute processing as described later. A program for performing the processing is previously stored in the memory 11b. The user can transmit various operation commands to the TV receiver 11 with a remote control 11c.

The TV receiver 11 also has an input section 11d as a content input section for receiving and inputting content received at the antenna 16 by a tuner circuit and an interface section (I/F) 11e with the network 15. Therefore, content data of a program of content and attribute information of program information of the program, etc., are input to the input section 11d.

The HDD 13 that can be accessed through the network 15 has a content storage section 13a for storing content data of a broadcast program, a metafile storage section 13b containing meta-information of the broadcast program, and a content information file 13c. Each storage section is a part of the storage area of the HDD 13. The content storage section 13a, the metafile storage section 13b, and the content information file 13c are provided corresponding to the specified level of the hierarchy.

The user can use the PC 12 not only to access the HDD 13 through the network 15, read data of any recorded program, and view the program, but also to perform operation of program data deletion, folder-to-folder move, etc., in the HDD 13.

The content storage management system 1 is used in such a manner that family members can view the TV receiver 11 at home and each of the family members can record any desired program in the HDD 13.

FIG. 2 is a drawing to show an example of a content management screen in the TV receiver 11. A content management screen 21 in FIG. 2 is displayed on a screen of display device of the TV receiver 11 as the user operates the remote control 11c in a predetermined manner. The content management screen 21 is a screen for displaying a directory tree in a tree format for enabling a folder to be set for each user and one or more folders to be set hierarchically in each folder. The CPU 11a implements a content management screen generation section for generating the content management screen 21 for displaying a predetermined directory tree as shown in FIG. 2.

In FIG. 2, a folder is set for each family member under the root directory. Using the content management screen 21 in FIG. 2, the user can specify the folder in which a program is to be recorded, thereby recording the program in the HDD 13 and further can specify a folder, thereby searching for any program to be viewed. FIG. 2 shows that a “daddy” folder 22 and a “mommy” holder 23 exist in the tree structure.

The programs contained in the selected folder are displayed in file units at the right of the content management screen 21.

For example, when performing programmed recording of a program, the user “daddy” or “mommy” specifies his or her holder in the directory tree and performs programmed recording. When searching for the program to be viewed, the user “daddy” or “mommy” also specifies his or her holder in the directory tree and displays a recording list as described later, whereby the user “daddy” or “mommy” can search for and select the program to be viewed. In other words, the content management screen 21 in FIG. 2 enables the user “daddy” or “mommy” to easily manage the program data under his or her folder.

The content management screen 21 shown in FIG. 2 is displayed on screens of the TV receiver 11 and the PC 12 and the user can perform operation of folder selection, file deletion, file move, etc., on the content management screen 21.

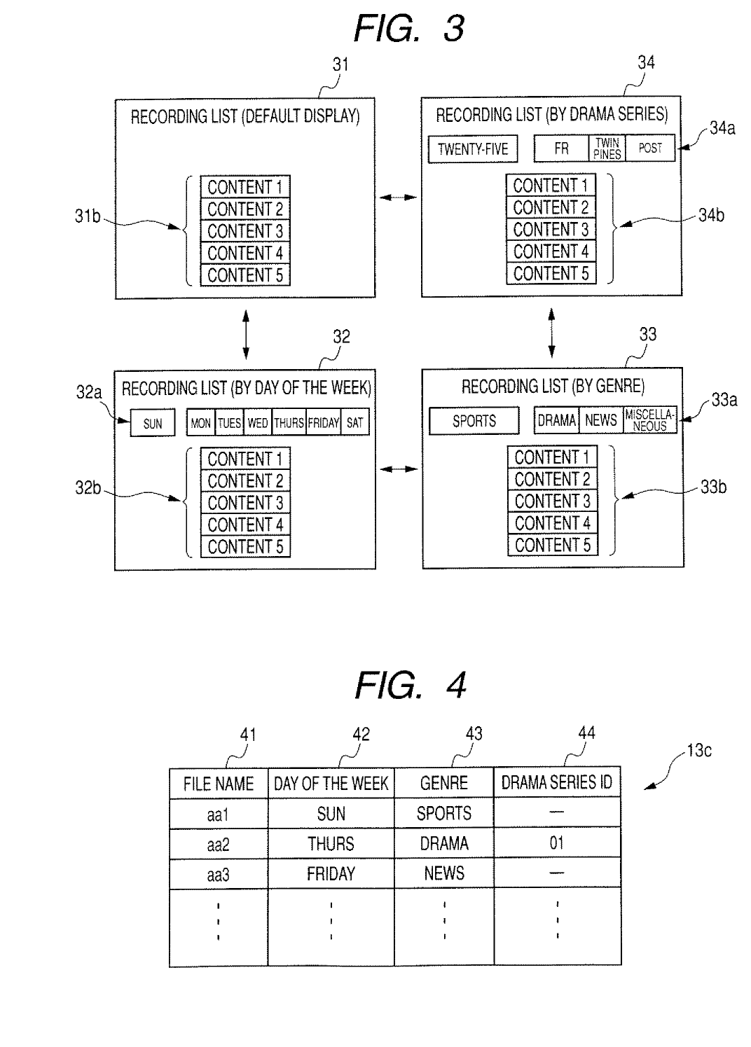

FIG. 3 is a drawing to describe a display example of a recording list. The recording list displays the programs recorded in the HDD 13 on a screen of the display device of the TV receiver 11 in the list format. The user can give a predetermined command to the TV receiver 11 with a predetermined input unit of a remote control, etc., thereby displaying various recording lists as in FIG. 3 on the screen of the TV receiver 11. Here, the following two types of recording lists are included: A recording list of default display for displaying all programs in the list format in a predetermined order, for example, in the order in which the programs were recorded and a categorized recording list for classifying programs according to the classification preset or specified by the user and displaying the programs in the list format in a predetermined order. Here, the following three types of categorized recording lists are included: A recording list by day of the week, a recording list by genre, and a recording list by drama series.

When the user desires to list all programs in his or her folder, namely, all contents, the user can operate the remote control 11c to display a screen 31 on the screen of the TV receiver 11. For example, if the user specifies the “daddy” folder 22 in FIG. 2 and gives a command of displaying a recording list of default display, all programs in the “daddy” folder 22 are listed.

When the user desires to list the recorded programs by recording day of the week from among all programs in his or her folder, the user can operate the remote control 11c to display a screen 32 on the screen of the TV receiver 11. The screen 32 is a recording list screen by day of the week. For example, for “daddy” in FIG. 2, all programs in the “daddy” folder 22 are listed for each specified day of the week. The screen 32 displays days of the week of low-order classification items of the classification item of the day of the week of classification information in a tab display section 32a in a tab or button (which will be hereinafter referred to as tab) format. Seven tabs are displayed corresponding to Monday to Sunday in the tab display section 32a of an item display section. On the screen 32, the user moves a cursor to the tab of the day of the week to display the recorded programs and selects the tab, whereby the programs recorded on the day of the week corresponding to the selected tab are listed in the center of the screen 32. That is, the programs corresponding to the selected tab, namely, day of the week are displayed on a listing section 32b.

When the user desires to list the recorded programs by genre from among all programs in his or her folder, the user can operate the remote control 11c to display a screen 33 on the screen of the TV receiver 11. The screen 33 is a recording list screen by genre. For example, for “daddy” in FIG. 2, all programs in the “daddy” folder 22 are listed for each genre. The screen 33 displays item names of sports, drama, etc., of low-order classification items of the classification item of the genre of classification information in a tab display section 33a in the tab format. Four tabs of sports, drama, news, and miscellaneous are displayed corresponding to the genre names in the tab display section 33a of an item display section. On the screen 33, the user moves a cursor to the tab of the genre to display the recorded programs and selects the tab, whereby the programs in the genre corresponding to the selected tab are listed in the center of the screen 33. That is, the programs corresponding to the selected tab, namely, genre are displayed on a listing section 33b.

Further, when the user desires to list the recorded programs by drama series from among all programs in his or her folder, the user can operate the remote control 11c to display a screen 34 on the screen of the TV receiver 11. The screen 34 is a recording list screen by drama series. For example, for “daddy” in FIG. 2, all programs in the “daddy” folder 22 are listed for each drama series. The screen 34 displays drama names of low-order classification items of the classification item of the drama series of classification information in a tab display section 34a in the tab format. Four tabs are displayed corresponding to the drama series names in the tab display section 34a of an item display section. On the screen 34, the user moves a cursor to the tab of the drama series to display the recorded programs and selects the tab, whereby the programs in the drama series corresponding to the selected tab are listed in the center of the screen 34. That is, the programs corresponding to the selected tab, namely, drama series are displayed on a listing section 34b.

As described above, when the programs matching the specified classification information such as “Sunday” by day of the week or “Sports” by genre are listed, the contents matching the specified classification information are extracted and are listed.

In order to display a recording list on the listing section 31b, 32b, 33b, or 34b, meta-information of content should also be acquired together. The TV receiver 11 receives SI (Service Information) information in addition to the video data of a program, namely, the content data. Therefore, the TV receiver 11 can extract necessary meta-information for each program from the SI information.

Hitherto, all metafiles including meta-information of all recorded programs have been searched, whereby not only the screen 31, but also a recording list by day of the week, by genre, or by drama series like the screen 32, 33, or 34 has been displayed on the screen of the TV receiver 11. However, as the number of the stored programs increases, much time is taken for display processing of each screen in the CPU 11b. For example, to list the programs recorded on one day of the week, all metafiles are searched with the data of the day of the week as a key and thus it takes time until a recording list is displayed.

In the embodiment, for displaying a recording list at high speed, the content information file 13c is provided in the HDD 13.

FIG. 4 is a drawing to show an example of the content information file 13c. The content information file 13c is a table containing a file name item column 41, a day-of-the week item column 42, a genre item column 43, and a drama series identifier, namely, ID item column 44. Classification information of the day of the week, the genre, and the drama series ID is stored corresponding to each file name. Here, the user specifies the day of the week, the genre, and the drama series as classification information.

The content information file 13c can be set for each folder in a directory tree.

Therefore, when a recording list as in FIG. 3 is displayed corresponding to each user of “daddy” or “mommy,” the content information file set for the folder of the user is referenced and each recording list in FIG. 3 is created. Further, for example, if folders of “hobby” and “job” are set at a level below the “daddy” folder 22, a content information file can also be set for each of the “hobby” and “job” folders. Consequently, the recording list in FIG. 3 also becomes a list corresponding to the level at which the content information file is set, namely, the folder.

That is, the content data and the metafile of each program are stored in the HDD 13 corresponding to each folder, namely, each level specified on a predetermined directory tree as shown in FIG. 2.

After a folder is specified and recording is started, when predetermined meta-information is extracted from the SI information, predetermined classification information extracted from the meta-information is added to the content information file 13c in FIG. 4. For example, it is assumed that the user “daddy” specifies his holder 22 and performs programmed recording. When recording the program is started in response to the programmed recording, if the content information file 13c at the folder level of the user “daddy” contains information of each item of classification information specified in the content information file 13c from the meta-information concerning the program being recorded, information of each item is written corresponding to the file name of the program being recorded. For a sports program recorded on Sunday, the file name is “aa1” and “Sunday” is stored in the day-of-the week item 42 and “Sports” is stored in the genre item 43. For file name “aa2,” data to the effect that the genre is “Drama” and “Drama series ID” is “01” is stored in the content information file 13c.

As described above, the content information file 13c is set for each specified level and predetermined classification information is stored as it is extracted from the meta-information.

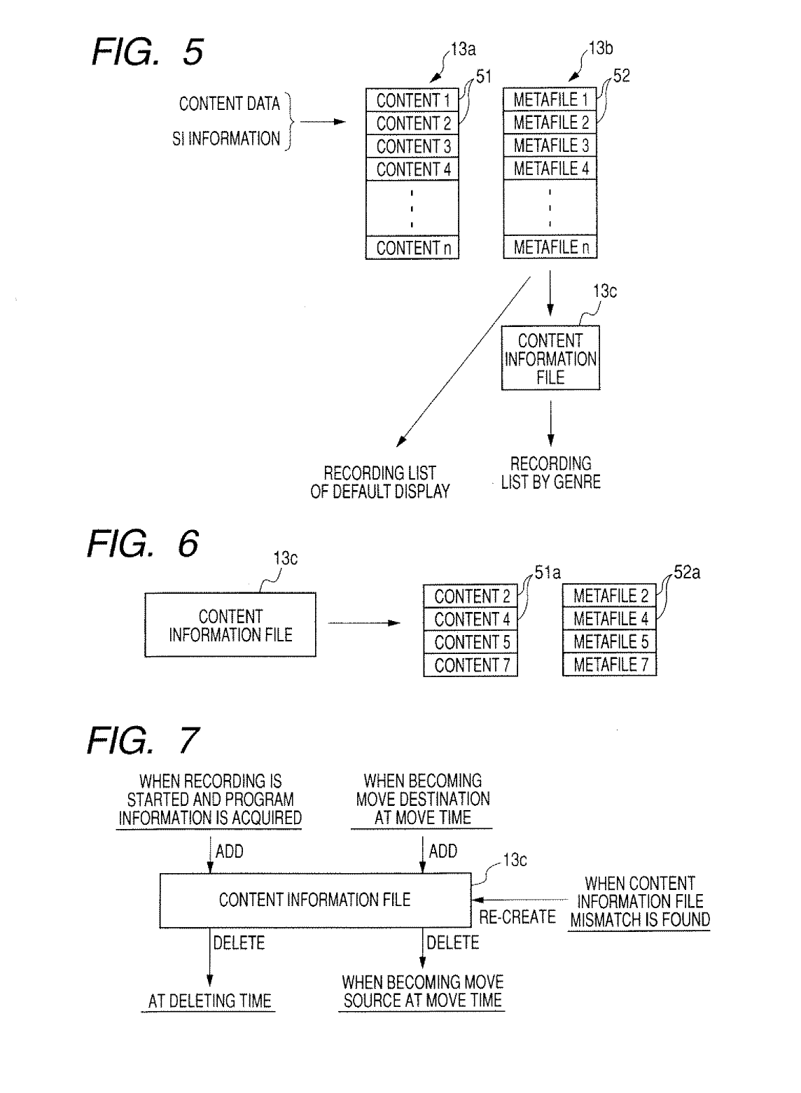

FIG. 5 is a drawing to describe the process in which a content information file is created from received program data.

The data received by the antenna 16 contains content data of program data and SI information about the content. When a program is recorded, the TV receiver 11 stores each piece of content data 51 in the HDD 13 and also stores a metafile 52 containing the meta-information of each content in the HDD 13 in association with each piece of content data 51. As described above, the meta-information of the title, the genre, the channel, etc., of the program is extracted from the SI information. Each piece of content data 51 is stored in the content storage section 13a and each metafile 52 is stored in the metafile storage section 13b.

The CPU 11a performs such processing of storing the content data 51 and the metafile 52 containing meta-information in the HDD 13 connected to the network 15. That is, the CPU 11a implements a content information storage section for storing the content data and the meta-information in the external storage connected to the network.

As described above, the classification information corresponding to the item of the content information file 13c is extracted from the meta-information and is added to the content information file 13c, whereby data in the content information file 13c is generated.

The CPU 11a performs such processing of extracting predetermined classification information from the meta-information and storing the classification information in the content information file 13c in the HDD 13. That is, the CPU 11a implements a content classification information storage section for extracting predetermined classification information from predetermined meta-information for each content and storing the classification information in the content information file 13c in the external storage connected to the network.

The categorized recording list in FIG. 3 is generated using the generated content information file 13c and is displayed, whereby the user can select any program to be viewed.

For example, to search the recorded programs for any program to be viewed, for example, the user displays a recording list as previously described with reference to FIG. 3 on the screen of the TV receiver 11 and specifies, namely, selects the program to be viewed out of the displayed list, whereby the content data of the program is read from the HDD 13 through the network 15 and the user can view the program with the TV receiver 11.

For example, when the user desires to view a program recorded on Sunday, the user gives a command to the TV receiver 11 with the remote control 11c so as to display the recording list by day of the week 32 on the screen of the TV receiver 11. Alternatively, when the user desires to view one of the recorded drams, he or she causes the TV receiver 11 to display the recording list by genre 33.

Upon reception of the command of displaying the categorized recording list, the TV receiver 11 extracts the data required for displaying the recording list from the content information file 13c and displays the recording list on the screen.

For example, when the user desires to view a program recorded on Sunday, the user gives a command of displaying the screen 32 of the recording list display screen by day of the week from the remote control 11c to the TV receiver 11. The TV receiver 11 reads the data in the content information file 13c, generates display data to display the screen 32, and displays the tab display section 32a and the listing section 32b on the screen. On the screen 32 in FIG. 3, Sunday is selected and the programs recorded on Sunday are listed in the listing section 32b.

Likewise, for example, if the user desires to view a recorded sports program, the user gives a command of displaying the screen 33 of the recording list display screen by genre from the remote control 11c to the TV receiver 11. The TV receiver 11 reads the data in the content information file 13c, generates display data to display the screen 33, and displays the tab display section 33a and the listing section 33b on the screen. On the screen 33 in FIG. 3, Sports is selected and the programs in the genre of Sports are listed in the listing section 33b.

If the user desires to view a drama series, similar processing is performed although not described.

When the contents matching the specified classification information are listed, the CPU 11a performs processing of extracting the contents matching the specified classification information from the content information file 13c based on the specified classification information. That is, the CPU 11a implements a content extraction section for extracting the contents matching the specified classification information from the content information file 13c based on the specified classification information when the contents matching the specified classification information are listed.

Further, the CPU 11a also performs processing of listing the contents matching the specified classification information based on the extracted contents. That is, the CPU 11a implements a listing information output section for outputting listing information to list the contents matching the specified classification information based on the extracted contents.

FIG. 6 is a drawing to describe processing of extracting specified content data and metafile from the content information file 13c.

As shown in FIG. 6, only content data 51a and metafile 52a in the specified class can be selected based on the content information file 13c.

As described above, when a categorized recording list is displayed in response to a command of displaying a categorized recording list from the user, the CPU 11a searches the content information file 13c according to the item description of “Sunday,” “Sports,” etc., specified by the user or as a default setting in the specified class, and extracts the corresponding content data 51a and metafile 52a. The CPU 11a displays the recording list in the listing section 32b, 33b, or 34b based on the extracted content data 51a and metafile 52a.

When the user selects, namely, specifies the content to be viewed, namely, played back out of the displayed recording list, the CPU 11a reads the selected content data 51a from the content storage section 13a of the HDD 13 and performs playback processing.

As described above, when a categorized recording list is displayed, the corresponding categorized recording list is displayed based on the data in the content information file 13c.

When the recording list screen of default display 31 is displayed, display data is generated based on all content data 51 in the content storage section 13a and information in all metafiles 52 in the metafile storage section 13b. The default display is display capable of displaying a recording list of all programs. Therefore, upon reception of a command of displaying a recording list of default display, the TV receiver 11 displays the recording list screen 31 for displaying a program recording list on the listing section 31b based on the information in all content data 51 and all metafiles 52 in the HDD 13.

The CPU 11a also performs processing of the default display. Therefore, the CPU 11a implements an all content extraction section for extracting all contents from all content data and all predetermined meta-information stored in the external storage when all contents are listed.

New data may be added to the content information file 13c or data may be deleted therefrom. FIG. 7 is a drawing to describe data addition to and data deletion from the content information file 13c.

As described above, when recording of a program is started according to programmed recording, etc., and SI information containing attribute information is acquired, a new file name and information of each item are added to the content information file 13c. Further, when the directory tree display screen in FIG. 2 is displayed on the screen of the TV receiver 11 or the PC 12 and a file is moved from one folder to another and the level of the content information file 13c becomes the move destination of the content, a new file name and information of each item are added to the content information file 13c.

When a file is deleted on the directory tree display screen in FIG. 2, the file name of the content and information of each item are deleted from the content information file 13c. Further, when a file is moved on the directory tree display screen in FIG. 2 and the level of the content information file 13c becomes the move source of the folder, the file name of the content and the information of each item are deleted from the content information file 13c.

To use the method of displaying each categorized recording list using the content information file 13c as described above, it is possible for the PC 12 to add or delete data to or from the file. If the PC 12 deletes one content, even if a categorized recording list is displayed on the screen of the TV receiver 11 based on the content information file 13c, the case where the content does not actually exist is also possible.

Therefore, if any other apparatus than the TV receiver 11, for example, the PC 12 adds or deletes content data or if recording does not normally terminates, a mismatch can occur between the contents of the content information file 13c and the program data actually existing in the HDD 13. That is, the case where the content stored in the content information file 13c is not contained in the contents actually existing in the HDD 13 can occur.

Then, if the information of the content actually existing in the HDD 13 and the information in the content information file 13c do not match, namely, if the content stored in the content information file 13c is not contained in the contents actually existing in the HDD 13, the TV receiver 11 according to the embodiment re-creates or corrects the content information file 13c to change the file.

Next, recording list display processing also containing change in data in the content information file 13c will be discussed.

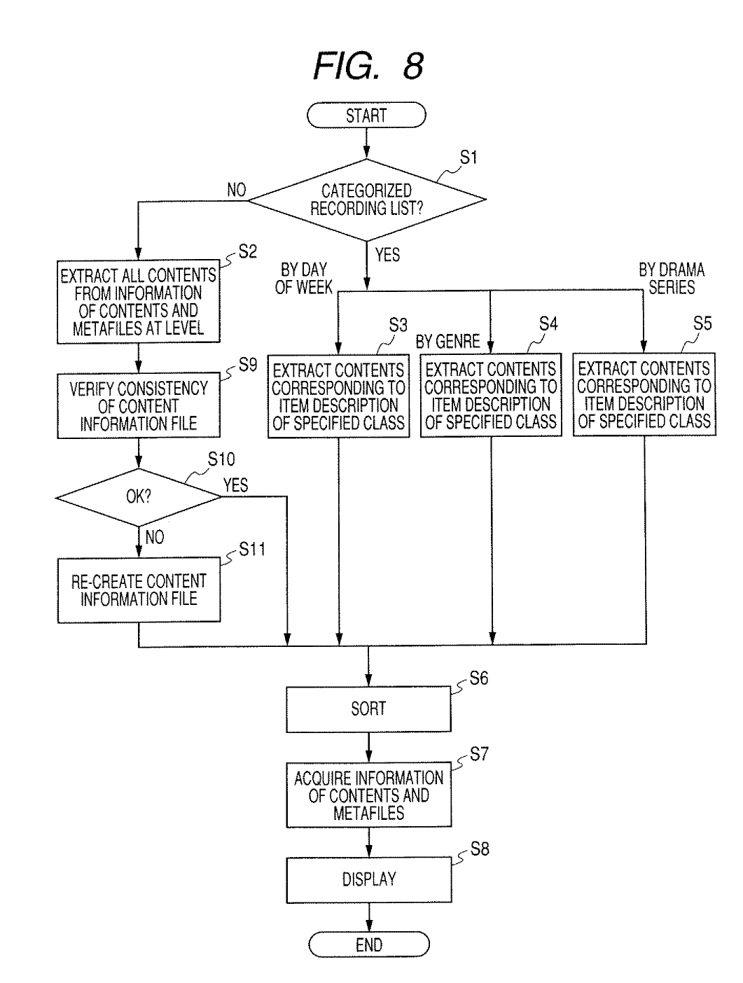

A flow of the recording list display processing will be discussed according to FIG. 8. FIG. 8 is a flowchart to show a flow example of the recording list display processing. The CPU 11a of the TV receiver 11 executes the processing in FIG. 8. When the user gives a recording list display command to the TV receiver 11 with the remote control 11c, the processing in FIG. 8 is executed. A display processing program is stored in the memory 11b and is read at the execution time and is executed by the CPU 11a.

Whether or not the recording list display command is a display command of a categorized recording list is determined (step S1). If the determination result at step S1 is NO, namely, if the command is a display command of a recording list of default display of the screen 31, all contents existing at the level are extracted from all information of the content data 51 and the metafiles 52 at the level, namely, in the folder (step S2). Information of all extracted contents is all file names, for example.

If the determination result at step S1 is YES, namely, if the command is a display command of a categorized recording list of any of the screen 32, 33, or 34, the CPU 11a extracts the contents matching, namely, corresponding to the item description of the specified class information from the information in the content information file 13c at the level, namely, in the folder (step S3, S4, S5). Here, step S3 corresponds to a recording list by day of the week, step S4 corresponds to a recording list by genre, and step S5 corresponds to a recording list by drama series.

For example, at step S3, S4, or S5, the content information file 13c is searched according to the default or user-specified item description of “Sunday,” “Sports,” etc., and information of the content corresponding to the item description, for example, the file name is extracted. The processing at each of steps S3, S4, and S5 corresponds to processing of the content extraction section.

When the corresponding content is extracted at step S3, S4, or S5, sort processing is performed (step S6). In the sort processing, the extracted contents are sorted in a predetermined order, for example, in the descending order or the ascending order of the recording dates and times. Consequently, for example, a list in which the file names are sorted in the ascending order of the recording dates and times is obtained.

Next, the CPU 11a acquires information of the content data 51a and the metafiles 52a corresponding to the sorted file names from the content storage section 13a and the metafile storage section 13b (step S7).

The CPU ha uses the acquired information of the content data 51a and the metafiles 52a to generate data of the screen 32, 33, or 34, and displays a recording list screen like the screen 32, 33, or 34 in FIG. 3 (step S8). Steps S7 and S8 corresponds to processing of the listing information output section.

After step S2, the CPU 11a makes a consistency check of the content storage section 13a (step S9).

The consistency check is to check whether or not each file name contained in the content storage section 13a at the level exists in the contents extracted at step S2.

Whether or not the contents existing at the level at the point in time and the content information file 13c match is determined according to the result of the consistence check at step S9 (step S10). If it is determined at step S10 that the contents existing at the level and the content information file 13c match, the determination result at step S10 is YES and the process goes to step S6 described above.

If the determination result at step S10 is NO, processing of re-creating the contents of the content information file 13c is executed (step S11).

The content information file 13c is changed as it is re-created from the information of all contents extracted at step S2.

If the part changed by deletion is known, the contents of the content information file 13c may be changed as the content information file 13c is corrected based only on the change part data.

The CPU 11a performs the processing at steps S9 and S10. Therefore, the CPU 11a at steps S9 and S10 implements a verifying section for checking whether or not the content stored in the content information file 13c exists in the extracted contents after all contents are extracted.

The CPU 11a also performs the processing at step S11. Therefore, the CPU 11a at step S11 implements a content information file change section for re-creating or correcting the contents of the content information file 13c to change the content information file 13c if the content stored in the content information file 13c does not exist in the extracted contents.

As described above, the content information file 13c is re-created only when a mismatch is found, so that the content information file 13c is efficiently managed.

For a conventional TV receiver, a conventional hard disk recorder, etc., with content of a broadcast program, etc., stored in an internal hard disk drive, data in the hard disk drive is rewritten, etc., only with the TV receiver, etc., and thus if content data is deleted, etc., the result of the data deletion, etc., is reflected on folder management, database management system, etc., of the TV receiver, the hard disk recorder, etc., because only one content management table is required.

However, if the storage for storing content is an external storage device connected through a network and is external storage that can also be accessed from an external system, deletion of the content stored in the external storage by any other apparatus connected to the network, for example, a PC is also possible.

In such a case, when the user displays a recording list to select the content to be viewed from among the contents stored in the external storage with the TV receiver, etc., content already deleted, etc., can exist in the entries in the recording list. If the displayed recording list contents and the contents actually existing in the external storage do not match, the user cannot appropriately search for content, etc., using the recording list.

In contrast, according to the TV receiver according to the embodiment described above, to store content in external storage that can also be accessed from any other external apparatus, a recording list can be displayed at high speed and if change in data in the external storage such as content deletion is made, a recording list can be displayed correctly with a content list corresponding to the data change.

As described above, according to the TV receiver according to the embodiment, to store content in external storage that can also be accessed from any other external apparatus connected to the network, any desired categorized recording list can be displayed at high speed.

In the embodiment, the TV receiver has been described as an example of the content storage management apparatus, but the content storage management apparatus may be a tuner rather than the TV receiver or may be implemented by providing an apparatus having a tuner like a set top box with the functions described above.

In the example, the external storage has been described as the hard disk drive connected to the network and accessible from the outside, but may be a PC installing storage, etc.

Further, in the description of the embodiment, the content of a program received at the antenna is taken as an example, but the input content may be content distributed through a network, etc.

All or apart of the code of the program for executing the operation described above is recorded or stored on a portable medium of a Floppy (registered trademark) disk, a CD-ROM, etc., in storage of a hard disk, etc., as a computer program product. The code of the program is read by a computer and all or a part of the operation is executed. Alternatively, all or a part of the program can be distributed or provided through a communication network. The user can download the program through a communication network and can install the program in a computer or can install the program in a computer from a record medium recording or storing the program, thereby easily implementing the content storage management apparatus of the invention.

It is to be understood that the present invention is not limited to the specific embodiment described above and that the present invention can be embodied with the components modified without departing from the spirit and scope of the claimed invention. The present invention may be embodied in various forms according to appropriate combinations of the components disclosed in the embodiment described above. For example, some components may be deleted from all components shown in the embodiment. Further, the components in different embodiments may be used appropriately in combination.

What is claimed is:

1. A content storage management apparatus comprising:
a content input section to which content data including content and attribute information of the content are input;
a content information storage section that stores the input content data and meta-information in an external storage device connected to the apparatus via a network, the meta-information being obtained for the content by analyzing the attribute information;
a content classification information storage section that extracts classification information from the meta-information for the content and stores the classification information in a content information file on the external storage device;
a content extraction section that extracts the content matching a specific type of the classification information from the content information file to be displayed as a list; and
a listing information output section that outputs listing information for displaying the content matching the specific type of the classification information based on the extracted content.

2. The apparatus according to claim 1, wherein the content information storage section stores the content data and the meta-information in association with a specified level on a predetermined directory tree,
wherein the content classification information storage section stores the classification information in the content information file associated with the specified level, and
wherein the content extraction section extracts the content matching the specific type of the classification information from the content information file associated with the specified level.

3. The apparatus according to claim 1 further comprising:
an all content extraction section that extracts all contents from all of the content data and meta-information stored in the external storage device when all of the content stored in the external storage device are to be listed; and
a verifying section that verifies whether or not the content stored in the content information file exists in the extracted content after the all content extraction section extracts all of the content stored in the external storage device.

4. The apparatus according to claim 1, wherein the content is content of a broadcast program, and
wherein the content storage management apparatus is one of a TV receiver and a tuner that receives the broadcast program.

5. The content storage management apparatus according to claim 1, wherein the listing information output section outputs information for displaying an item display section for displaying low-order classification items contained in the classification information and for displaying the list of the contents matching the low-order classification item selected in the item display section.

6. The apparatus according to claim 2 further comprising a content management screen generation section that generates a content management screen for displaying the directory tree,
wherein the level is specified when a folder in the directory tree displayed on the content management screen is selected.

7. The apparatus according to claim 3, wherein the verifying section performs a comparison between file names of all of the content extracted by the all content extraction section and file names of contents stored in the content information file to verify consistency.

8. The apparatus according to claim 3 further comprising a content information file change section that re-creating or correcting the content information file to change the content information file when the content stored in the content information file does not exist in the extracted content.

9. The apparatus according to claim 1 further comprising a display device that displays the list based on the listing information output by the listing information output section.

10. A method for managing stored content, the method comprising:
inputting content data including content and attribute information of the content;
obtaining meta-information for the content by analyzing the attribute information;
storing the input content data and the meta-information in an external storage device connected to the apparatus via a network;
extracting classification information from the meta-information for the content;
storing the classification information in a content information file on the external storage device;
extracting the content matching a specific type of the classification information from the content information file to be displayed as a list; and
outputting listing information for displaying the content matching the specific type of the classification information based on the extracted content.
